(19) United States
(12) Patent Application Publication
(10) Pub. No.: US 2025/0288928 A1
(43) Pub. Date: Sep. 18, 2025

(54) FILTER MATERIAL COMPRISING NANOFIBER LAYER AND FILTER ELEMENT COMPOSED OF SUCH FILTER MATERIAL

(71) Applicant: Carl Freudenberg KG, Weinheim (DE)

(72) Inventors: Benedikt KOSS, Mannheim (DE); Tobias SCHOLZ, Canton, MI (US); Jan Thomas GOEBEL, Birkenau (DE); Madeline BREY, Weinheim (DE); Heiko SCHACHT, Weinheim (DE); Jochen HERMANN, Reichenbach-Steegen (DE); Lukas GAERTNER, Weinheim (DE)

(21) Appl. No.: 18/657,822

(22) Filed: May 8, 2024

(30) Foreign Application Priority Data
Mar. 18, 2024 (EP) 24 164 057.2

(51) Int. Cl. B01D 39/20; B01D 29/03

(52) U.S. Cl. CPC B01D 39/2062; B01D 29/031; B01D 2239/0241; B01D 2239/025; B01D 2239/0407; B01D 2239/0654

(57) ABSTRACT

A filter material for air filtration in a filter element, including an inflow-side pre-filter layer, an active carbon layer, and a composite layer which is in the form of a fine filter layer including nanofibers. The pre-filter layer, the active carbon layer and the composite layer are connected to one another in materially bonded fashion. The composite layer includes at least one top layer, a nanofiber layer and a carrier layer.

### CROSS REFERENCE TO RELATED APPLICATIONS

This application claims benefit to European Patent Application No. 24 164 057.2, filed on Mar. 18, 2024, which is hereby incorporated by reference herein.

### FIELD

The invention relates to a filter material for air filtration in a filter element, and to a filter element comprising such filter material.

### BACKGROUND

Filters for filtration of fluids, in particular of air, are known from the prior art. For this purpose, the filter elements are usually inserted in filter housings and flowed through by air.

A wide variety of filter elements for filtering interior air are known from the prior art. DE 10 2013 011 457 A1 describes, for example, an interior air filter element for the driver's cab of agricultural or work machines.

The interior air filter element comprises an adsorption filter layer comprising active carbon, a fine filter layer, in particular for arrestance of aerosols, and an encircling seal for separating the untreated side from the clean side when installed in a filter housing. A filter with multiple stages of this kind is also referred to as multi-stage filter. The provision of a pleated pre-filter layer makes it possible for the adsorption layer and the fine filter layer to be protected against too great a dust loading and for the function thereof to be ensured for as long as possible. A disadvantage of this structure is that the pre-filter layer needs additional installation space and the filter element can be constructed less compactly.

### SUMMARY

In an embodiment, the present disclosure provides a filter material for air filtration in a filter element, comprising an inflow-side pre-filter layer, an active carbon layer, and a composite layer which is in the form of a fine filter layer comprising nanofibers. The pre-filter layer, the active carbon layer and the composite layer are connected to one another in materially bonded fashion. The composite layer comprises at least one top layer, a nanofiber layer and a carrier layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a first embodiment of a filter material in a sectional illustration;

FIG. 2 illustrates a second embodiment of a filter material in a sectional illustration;

FIG. 3 illustrates a third embodiment of a filter material in a sectional illustration;

FIG. 4 illustrates a fourth embodiment of a filter material in a sectional illustration;

FIG. 5 illustrates a detail from a view of a filter element after pleating has been effected; and

FIG. 6 illustrates a filter element comprising a filter material in a spatial illustration.

### DETAILED DESCRIPTION

In an embodiment, the present invention provides a filter material which has a filtration efficiency that is more stable over the period of use compared with known filter materials, with an unchanged installation space requirement.

According to an embodiment of the invention, it has been recognized as advantageous to combine a pre-filter layer, an active carbon layer as adsorption layer and a composite layer comprising nanofibers in a filter material.

The filter material according to an embodiment of the invention is used for air filtration in a filter element. It has an inflow-side pre-filter layer, which is embodied as a coarse dust filter layer, an active carbon layer as adsorption layer and a composite layer as mechanical filter medium. The composite layer is in the form of a fine filter layer comprising nanofibers, which can be designed, for example, with an EPA (Efficient Particulate Air) property.

According to an embodiment of the invention, the composite layer comprises a nanofiber layer on a carrier layer, the nanofiber layer being provided on its other side with a top layer. The layers are connected to one another in materially bonded fashion. The carrier layer can consist of coarse fibers and the top layer of coarse fibers and/or microfibers.

According to an embodiment of the invention, the pre-filter layer, the active carbon layer and the composite layer are also connected to one another in materially bonded fashion. The layers are thus connected not in form-fitting fashion by co-pleating, that is to say not by common folding of the layers, but in materially bonded fashion. This materially bonded connection is also referred to as “being laminated to one another”.

The materially bonded connection by any type of lamination can be effected by means of adhesive bonding (polymer threads, powders, M-Web, reactive or thermal adhesive such as thermoplastic hotmelt, etc.), thermal compression (calendering with/without melt fiber content) or by means of ultrasonic welding or ultrasonic calendering. The materially bonded connection can be present in a full-area or punctiform manner over the surface of the layers.

Advantages of the materially bonded connection of the layers compared with the co-pleated connection can be seen in a higher mechanical stability. A further advantage is a higher temperature stability: After heated storage of the filter material, a lower pressure drop increase can be observed compared with a co-pleated filter material with otherwise identical structure. The filter material with its layers connected in materially bonded fashion can also be readily pleated as a whole. Without a materially bonded connection, it is generally possible for at most two layers to be co-pleated together. A further layer then has to be pleated separately, and therefore a filter element is made up of two layers, namely the pleated layer and the co-pleated layer. However, such a filter element made up of multiple layers then needs a larger installation space. By virtue of the materially bonded connection of all the layers, it is thus possible to produce a filter medium with three and more layers, which during subsequent pleating has a lower installation space requirement compared with co-pleated filter media.

By virtue of the combination of the pre-filter layer and of the composite layer comprising nanofibers in a filter material, at the same time a high dust holding capacity with a high quality factor is achieved. In relation to its thickness, such a material exhibits good values: using the filter material in a filter makes it possible to achieve a good filtration efficiency without an increase in the pressure drop.

The advantage of nanofibers compared with thicker fibers is that these have a larger surface area and thus enable improved filtration performance and a longer filter service life. Particularly the high barrier effect (interception effect) owing to the small fiber diameters has a positive effect here. In contrast to electrostatic arrestance, the effect which can be attributed to the mechanical arrestance remains largely unchanged over the operating life of a filter. In addition, filter media composed of nanofibers have a lower pressure drop, accompanied by a lower energy demand for the filter element.

The filter material according to an embodiment of the invention comprises an adsorption layer, in the form of an active carbon layer, i.e. it has a layer comprising a proportion of active carbon as adsorbent. A filter element composed of such a filter material is referred to as a combination filter.

In an advantageous embodiment of the filter medium, the layers are connected by adhesive bonding using a polyolefinic hotmelt as thermoplastic melt adhesive. This has the following advantages:
good adhesion properties to the substrates to be adhesively bonded,
a high heat stability of >105° C.,
stability with regard to oxidative degradation processes,
high aging resistance and
inconspicuity with regard to fogging and odor.

The layers of the composite layer can also be adhesively bonded to one another by means of polyolefinic hotmelt.

In an embodiment of the invention, in the filter material, the pre-filter layer and/or the composite layer are/is electrostatically charged, for example by means of Corona or high-voltage technology. This makes it possible to further improve the dust holding capacity.

In a possible embodiment variant of the filter material, the active carbon layer is equipped with a permanently tacky adhesion mesh. The permanently tacky adhesion mesh can also be referred to as mesh-like adhesion layer, which is introduced into the active carbon layer. For the structure of the adhesion layer, use can be made of a polyolefinic hotmelt, with filaments having a diameter of 5 to 20 μm which form the adhesion mesh. As a result of the permanently tacky adhesion mesh, it is advantageously possible especially for coarser dust particles to be arrested and thus subsequent layers to be protected. A further function of the adhesion mesh is to bind and fix the adsorber particles of the active carbon layer.

In an embodiment of the filter material, the filter material comprises an additional coarse filter layer, which can also be referred to as coarse dust filter layer. The function of the coarse dust filter layer is to provide a carrier structure for the active carbon layer or a support structure for the composite layer and also to contribute to the filtration. Advantages of such a filter material are thus a higher stability and higher dust holding capacity. A higher dust holding capacity contributes to keeping the pressure drop increase of the filter element over the period of use as low as possible, in particular in spite of the presence of the high-arrestance nanofibers. To this end, the coarse dust filter layer can be arranged upstream of the composite layer as seen in the throughflow direction.

In an embodiment of the filter material, the pre-filter layer or the possibly present coarse filter layer form a carrier and thus a support structure for the active carbon layer. The active carbon layer can also be constructed in particular from active carbon particles which are adhesively bonded to one another.

Particularly in the case of an active carbon layer which comprises a multiplicity of individual active carbon particles, it is customary in the prior art for the bed of these particles to be applied to a support structure and to be secured by adhesive bonding. If, as disclosed here, the pre-filter layer or the possibly present coarse filter layer is used as carrier, then the pre-filter layer or the possibly present coarse filter layer can also perform a filtration function, further increasing the filtration performance of the filter material.

Different variants of the filter material are provided, which differ in terms of their structure. The structure of the composite layer is consistent—as seen in the throughflow direction—as follows: carrier layer, nanofiber layer, top layer.

In a first variant, the filter material has an inflow-side pre-filter layer, an outflow-side composite layer and an interposed active carbon layer.

This results in the following order of the layers as seen in the throughflow direction:
1.) Pre-filter layer
2.) Active carbon layer
3.) Composite layer

In a second variant, the filter material has an inflow-side pre-filter layer, an outflow-side coarse filter layer with active carbon layer applied thereto and an interposed composite layer, in particular the pre-filter layer and the composite layer being in the form of a unit which is connected together in materially bonded fashion, for example by means of thermal welding.

This results in the following order of the layers as seen in the throughflow direction:
1.) Pre-filter layer
2.) Composite layer
3.) Active carbon layer
4.) Coarse filter layer

In a third variant, the filter material has an inflow-side pre-filter layer, with active carbon layer applied thereto, the active carbon layer being downstream of the pre-filter layer, an outflow-side composite layer and an interposed coarse filter layer, in particular the coarse filter layer and the composite layer being in the form of a unit which is connected together in materially bonded fashion and being adhesively bonded together for example using thermoplastic hotmelt.

This results in the following order of the layers as seen in the throughflow direction:
1.) Pre-filter layer
2.) Active carbon layer
3.) Coarse filter layer
4.) Composite layer

In a fourth variant, an inflow-side pre-filter layer, a coarse filter layer with active carbon layer applied thereto, a further coarse filter layer and an outflow-side composite layer are present. In particular, the further coarse filter layer and the composite layer are in the form of a unit which is connected together in materially bonded fashion, for example by means of thermal welding.

This results in the following order of the layers as seen in the throughflow direction:
1.) Pre-filter layer
2.) Active carbon layer
3.) Coarse filter layer
4.) Coarse filter layer
5.) Composite layer

A unit which is connected together in materially bonded fashion in the second, third and fourth variant means that the pre-filter layer and composite layer or the coarse filter layer and composite layer have already been connected to one another in materially bonded fashion by a preceding process, before the materially bonded connection to the further layers is effected in a further process step. The materially bonded connection of the pre-filter layer or of the coarse filter layer and of the composite layer can be effected thermally in a full-area manner and/or by punctiform layer welding.

As a result, a particularly high strength and good processability of the filter material can be achieved.

In an embodiment of the filter material, the latter has a progressive structure in such a way that the porosity of the layers, pre-filter layer, active carbon layer and composite layer, gradually decreases from an inflow side (untreated gas side) to an outflow side (clean gas side) of the filter material from one layer to the next layer. Here, porosity is understood to be the ratio of cavity volume to total volume of a respective nonwoven layer. Or in other words: progressive structure means that the layers—as seen in the throughflow direction—become increasingly finer. A filter material of this kind offers particularly good dust filtration and a filter material pressure difference that is stable over time.

An embodiment of the invention also relates to a filter element comprising a pleated filter material as described above.

In an embodiment of the filter element, edge strips or frame elements can be attached to the pleated filter material, which stabilize the filter element and can be used as sealing elements with respect to a filter housing accommodating the filter element.

An embodiment of the invention also relates to the use of a filter element, as described above, as an interior air filter for filtration and cleaning of the cabin supply air in a vehicle, in particular in a car, a utility vehicle or a bus.

The described embodiments of the invention and the described advantageous developments of the invention also constitute advantageous developments of the invention when combined with one another-if this is technically expedient.

Reference is made to the description of exemplary embodiments with reference to the appended figures with regard to further advantages and embodiments of the invention which are advantageous in terms of design and function.

Embodiments of the invention will be explained in more detail on the basis of attached figures. Elements and components which correspond to one another are denoted by identical reference designations in the figures. For the benefit of better clarity of the figures, an illustration that is true to scale is dispensed with.

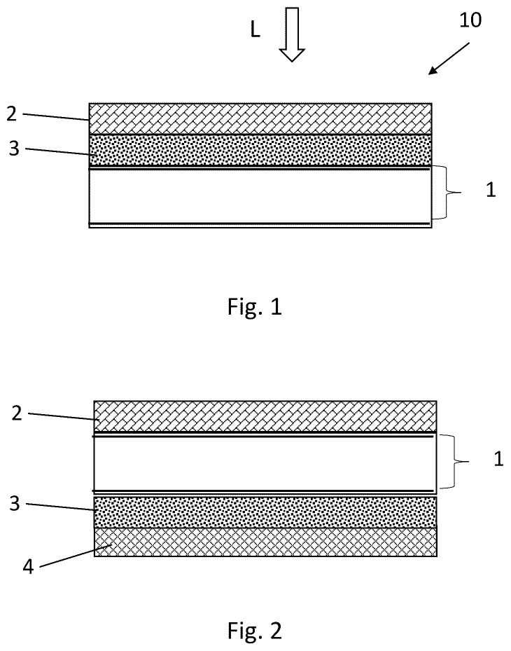

FIG. 1 shows a first embodiment variant of the filter material 10 in a sectional illustration. The throughflow direction of the air flow is illustrated by an arrow L. The filter material 10 comprises an inflow-side pre-filter layer 2, a central active carbon layer 3 and an outflow-side composite layer 1, which is in the form of a fine filter layer comprising nanofibers. The composite layer 1 has a plurality of layers, namely a covering layer, a nanofiber layer and a carrier layer, the layers being connected to one another in materially bonded fashion. The covering layer and the carrier layer are only indicated in the drawing. The other embodiment variants described below also have this structure of the composite layer 1. The pre-filter layer 2, the active carbon layer 3 and the composite layer 1 are connected to one another in materially bonded fashion using thermoplastic hotmelt. The covering layer, the nanofiber layer and the carrier layer of the composite layer 1 can be connected to one another also using thermoplastic hotmelt or by thermal welding.

FIG. 2 shows a second embodiment variant of the filter material 10 in a sectional illustration. An inflow-side pre-filter layer 2, an outflow-side coarse filter layer 4 with active carbon layer 3 applied upstream thereto and an interposed composite layer 1 are provided.

The pre-filter layer 2 and the composite layer 1 are connected to one another by thermal welding. The composite layer 1, the active carbon layer 3 and the coarse filter layer 4 are connected to one another in materially bonded fashion using thermoplastic hotmelt. The covering layer, the nanofiber layer and the carrier layer of the composite layer 1 can be connected to one another using thermoplastic hotmelt or by thermal welding.

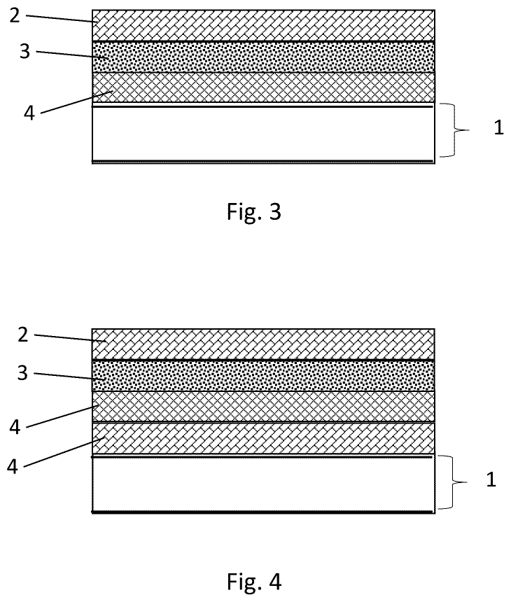

FIG. 3 shows a third embodiment variant of the filter material 10 in a sectional illustration. Here, use is made of an inflow-side pre-filter layer 2, an outflow-side composite layer 1 and an interposed coarse filter layer 4 with active carbon layer 3 applied thereto, the active carbon layer 3 being arranged upstream of the coarse filter layer 4.

The coarse filter layer 4 and the composite layer 1 are connected to one another in materially bonded fashion using thermoplastic hotmelt. The pre-filter layer 2, the active carbon layer 3 and the coarse filter layer 4 are connected to one another using thermoplastic hotmelt. The covering layer, the nanofiber layer and the carrier layer of the composite layer 1 can be connected to one another using thermoplastic hotmelt or by thermal welding.

FIG. 4 shows a fourth embodiment variant of the filter material 10 in a sectional illustration. In contrast to the variant according to FIG. 3, use is made of a further filter layer, namely a coarse filter layer 4, which is positioned upstream of the composite layer 1.

The coarse filter layer 4 and the composite layer 1 are connected to one another by thermal welding. The pre-filter layer 2, the active carbon layer 3 and both coarse filter layers 4 are connected to one another in materially bonded fashion using thermoplastic hotmelt. The covering layer, the nanofiber layer and the carrier layer of the composite layer 1 can be connected to one another using thermoplastic hotmelt or by thermal welding.

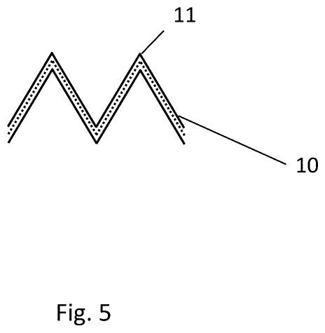

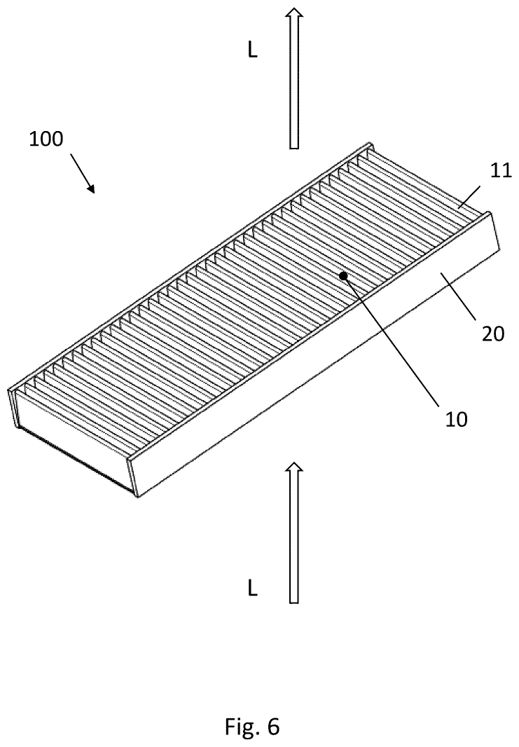

FIG. 5 shows a detail from a view of the filter material 10—independently of the structure thereof composed of multiple layers—after pleating has been effected. A folded edge is marked by way of example with 11.

FIG. 6 shows a filter element 100 comprising the filter material 10 in a spatial illustration. The filter element 100 comprising the filter material 10, which can be designed as in FIGS. 1 to 4 and has been pleated as illustrated in FIG. 5, has edge strips 20 attached to the pleated filter material 10 which contribute to a stabilization of the filter element 100 and can effect sealing in relation to a filter receptacle.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE DESIGNATIONS

1 Composite layer comprising nanofiber layer
2 Pre-filter layer
3 Active carbon layer
4 Coarse filter layer
10 Filter material
11 Folded edge
20 Edge strip
100 Filter element
L Throughflow direction of air flow

1. A filter material for air filtration in a filter element, comprising:
an inflow-side pre-filter layer;
an active carbon layer; and
a composite layer, which is in the form of a fine filter layer comprising nanofibers, wherein the pre-filter layer, the active carbon layer and the composite layer are connected to one another in materially bonded fashion, and
wherein the composite layer comprises at least one top layer, a nanofiber layer and a carrier layer.

2. The filter material as claimed in claim 1, wherein the pre-filter layer and/or the composite layer are/is electrostatically charged.

3. The filter material as claimed in claim 1, wherein the active carbon layer is equipped with a permanently tacky adhesion mesh.

4. The filter material as claimed in claim 1, further comprising a coarse filter layer.

5. The filter material as claimed in claim 4, wherein the pre-filter layer or the coarse filter layer form a carrier for the active carbon layer.

6. The filter material as claimed in claim 1, wherein the active carbon layer is constructed from active carbon particles which are adhesively bonded to one another.

7. The filter material as claimed in claim 1, wherein the filter material has the following structure:
the inflow-side pre-filter layer, the composite layer on an outflow side, and the active carbon layer interposed.

8. The filter material as claimed in claim 4, wherein the filter material has the following structure:
the inflow-side pre-filter layer, the coarse filter layer on an outflow side with the active carbon layer applied thereto and the composite layer interposed.

9. The filter material as claimed in claim 1, wherein the filter material has the following structure:
the inflow-side pre-filter layer, the composite layer on an outflow side, at least one coarse filter layer and the active carbon layer interposed.

10. The filter material as claimed in claim 1, wherein the layers of the filter material have a progressive structure.

11. A filter element comprising the filter material as claimed in claim 1, wherein the filter material is pleated and edge strips or frame elements are attached to the pleated filter material.

12. The filter material as claimed in claim 8, wherein the pre-filter layer and the composite layer are formed and connected together as a materially bonded unit.

13. The filter material as claimed in claim 9, wherein the active carbon layer is applied upstream to a first coarse filter layer and a second coarse filter layer and the composite layer are formed and connected together as a materially bonded unit.
